(19) United States
(12) Patent Application Publication
(10) Pub. No.: US 2016/0197348 A1
(43) Pub. Date: Jul. 7, 2016

(54) POSITIVE ELECTRODE ACTIVE MATERIAL FOR NONAQUEOUS ELECTROLYTE SECONDARY BATTERY AND NONAQUEOUS ELECTROLYTE SECONDARY BATTERY USING THE SAME

(71) Applicant: SANYO ELECTRIC CO., LTD., Daito-shi, Osaka (JP)

(72) Inventors: Daizo Jito, Hyogo (JP); Takeshi Ogasawara, Hyogo (JP); Hiroyuki Fujimoto, Osaka (JP)

(73) Assignee: SANYO ELECTRIC CO., LTD., Daito-shi, Osaka (JP)

(21) Appl. No.: 14/911,089

(22) PCT Filed: Sep. 11, 2014
(86) PCT No.: PCT/JP2014/004691

§ 371 Date: Feb. 9, 2016

(30) Foreign Application Priority Data
Sep. 30, 2013 (JP) 2013-203345

(51) Int. Cl. H01M 4/62; H01M 4/485; H01M 10/0525; H01M 4/131

(52) U.S. Cl. CPC H01M 4/62; H01M 4/131; H01M 4/485; H01M 10/0525; H01M 2004/028

(57) ABSTRACT

A positive electrode active material for a nonaqueous electrolyte secondary battery having excellent low-temperature output characteristics and a nonaqueous electrolyte secondary battery using the same are provided. According to an aspect of the positive electrode active material for a nonaqueous electrolyte secondary battery of the present invention, a compound containing a rare earth element and a compound containing lithium and fluorine are attached to a surface of a positive electrode active material formed of a lithium transition metal oxide. The compound containing a rare earth element attached to the surface of the positive electrode active material is preferably at least one selected from a hydroxide, an oxyhydroxide, a phosphate compound, a carbonate compound, and an oxide.

### TECHNICAL FIELD

The present invention relates to a nonaqueous electrolyte secondary battery and a nonaqueous electrolyte secondary battery using the same.

### BACKGROUND ART

In the field of nonaqueous electrolyte secondary batteries, further improvements on various properties are required, such as higher capacitance, longer lifetime, higher output, and higher safety. For example, Cited Document 1 proposes providing a rare earth oxide on a surface of an active material in order to suppress side reactions between a positive electrode and an electrolyte at high voltage and improve cycle properties. Cited Document 2 proposes coating a surface of an active material with a fluorine compound such as LiF or AlF₃ in order to suppress side reactions between a positive electrode and an electrolyte at high voltage and improve cycle properties.

### CITATION LIST

### Patent Literature

PTL 1: WO 2005-008812
PTL 2: Japanese Unexamined Patent Application Publication (Translation of PCT Application) No. 2008-536285

### SUMMARY OF INVENTION

### Technical Problem

However, the above-described proposals have a problem in that degradation of output characteristics occurs at low temperature.

An object of the present invention is to improve output characteristics of nonaqueous electrolyte secondary batteries at low temperature.

### Solution to Problem

According to an aspect of the positive electrode active material for a nonaqueous electrolyte secondary battery of the present invention, a compound containing a rare earth element and a compound containing lithium and fluorine are attached to a surface of a positive electrode active material formed of a lithium transition metal oxide.

### Advantageous Effects of Invention

According to an aspect of the nonaqueous electrolyte secondary battery of the present invention, a nonaqueous electrolyte secondary battery that uses the positive electrode active material exhibits significantly improved output at low temperature.

### DESCRIPTION OF EMBODIMENTS

A positive electrode active material for a nonaqueous electrolyte secondary battery is characterized in that a compound containing a rare earth element and a compound containing lithium and fluorine are attached to a surface of a positive electrode active material formed of a lithium transition metal oxide.

According to an aspect of the positive electrode active material for a nonaqueous electrolyte secondary battery of the present invention, the compound containing a rare earth element is preferably a hydroxide, an oxyhydroxide, an oxide, a phosphate compound, or a carbonate compound, and more preferably a hydroxide or an oxyhydroxide of a rare earth. This is because use of these materials further improves low-temperature output.

According to an aspect of the positive electrode active material for a nonaqueous electrolyte secondary battery of the present invention, the compound containing lithium and fluorine is preferably LiF.

An example of a method for causing a compound containing a rare earth element and a compound containing lithium and fluorine to attach to particle surfaces of a lithium transition metal oxide is a method that involves spraying or adding dropwise a solution of a rare earth salt and a solution of a fluorine salt onto a lithium transition metal oxide while the lithium transition metal oxide is being stirred. The solution of a rare earth salt and the solution of a fluorine salt may be prepared by using water or an organic solvent such as an alcohol. Preferably, the solutions are prepared by using water.

When an aqueous solution of a rare earth salt is sprayed onto lithium transition metal oxide powder, lithium hydroxide and lithium carbonate attached to the powder surface become instantaneously dissolved at the contact interface between powder and the solution, thereby turning the solution alkaline, and thus the rare earth salt attaches to the powder surface by forming a rare earth hydroxide. A hydroxide of a rare earth element turns into an oxyhydroxide at about 200° C. to about 350° C. An oxyhydroxide of a rare earth turns into an oxide at about 400° C. to about 500° C. For example, when the rare earth element is erbium, erbium oxyhydroxide is generated at 230° C. and erbium oxide is generated at 440° C.

Spraying a fluorine-containing aqueous solution onto lithium transition metal oxide powder causes lithium hydroxide and lithium carbonate attached to the powder surface to react with fluorine ions. For example, when an aqueous ammonium fluoride solution is used, lithium fluoride is precipitated. The rest of the product is ammonia and water.

Subsequently, drying or a heat treatment is preferably conducted at a temperature of 350° C. or lower so as to remove moisture and dry. The temperature is particularly preferably 250° C. or lower. When a sulfuric acid solution of erbium is used as the aqueous solution of a rare earth salt and an aqueous ammonium fluoride solution is used as the solution of a fluorine salt, erbium hydroxide and lithium fluoride are precipitated during this process. Since a hydroxide turns into an oxyhydroxide at 230° C., a compound containing an oxyhydroxide of erbium and lithium fluoride attaches to a surface of a lithium transition metal oxide as a result of a heat treatment at 250° C. When the heat treatment is performed at 200° C., a hydroxide of erbium and lithium fluoride remain as are.

When the heat treatment is performed at 400° C. or higher, the rare earth compound starts to react with lithium fluoride, and a rare earth fluoride is likely to occur. At a temperature exceeding 500° C., the rare earth compound attached to the surface not only reacts with lithium fluoride but also diffuses into the interior of the active material, thereby decreasing the initial charge-discharge capacity. Thus, the heat treatment temperature is preferably 350° C. or lower and more preferably 250° C. or lower. The lower limit of the heat treatment and drying temperature is preferably about 80° C.

### EXPERIMENTAL EXAMPLES

The present invention will now be described in further details through Experimental Examples which do not limit the scope of the present invention. Various modifications and alterations are possible within the gist of the present invention.

### Experimental Example 1

### Preparation of Positive Electrode Active Material

After mixing [Ni_{0.35}Mn_{0.30}Co_{0.35}](OH)₂ prepared by a co-precipitation technique with Li₂CO₃, the resulting mixture was baked in air at 950° C. for 10 hours. As a result, a lithium transition metal oxide represented by Li_{1.06}[Ni_{0.33}Mn_{0.28}Co_{0.33}]O₂ was obtained as a positive electrode active material. The average particle diameter of the lithium transition metal oxide was about 10 μm.

While 1000 g of powder of the lithium transition metal oxide prepared by the method described above was being stirred, a solution prepared by dissolving 3.76 g of erbium acetate tetrahydrate in 50 mL of pure water was added to the powder in divided portions. Simultaneously, 30 mL of an aqueous solution of 0.94 g of ammonium fluoride was also added to the powder in divided portions. Addition was conducted in such a manner that the erbium acetate tetrahydrate solution and the aqueous ammonium fluoride solution did not directly mix with each other until the solutions came into contact with the lithium transition metal oxide powder.

The resulting powder was dried at 120° C. for 2 hours and heat-treated at 250° C. for 6 hours. The amount of the erbium oxyhydroxide attached to the powder in terms of erbium element was 0.14% by mass relative to the lithium transition metal oxide and the amount of fluorine in terms of fluorine element was 0.05% by mass.

[Preparation of Positive Electrode]

The positive electrode active material, carbon black serving as a conductive agent, and an N-methyl-2-pyrrolidone solution of polyvinylidene fluoride serving as a binder were weighed so that the positive electrode active material/conductive agent/binder mass ratio was 92:5:3, and then mixed and kneaded to prepare a positive electrode mixture slurry.

The positive electrode mixture slurry was applied to both surfaces of a positive electrode current collector formed of an aluminum foil, dried, and rolled with a rolling roller. Current collecting tabs formed of aluminum were attached to the resulting product to prepare a positive electrode.

A three-electrode test cell, which included the positive electrode described above serving as a working electrode, and a counter electrode and a reference electrode formed of lithium metal, was prepared. The nonaqueous electrolyte used was a nonaqueous electrolyte prepared by dissolving LiPF₆ in a mixed solvent containing ethylene carbonate, methyl ethyl carbonate, and dimethyl carbonate at a volume ratio of 3:3:4 so that the concentration of LiPF₆ was 1 mol/L, and then dissolving vinylene carbonate therein so that the vinylene carbonate concentration was 1% by mass relative to the mixed solvent. The three-electrode test cell prepared as such is hereinafter referred to as a cell A1.

### Experimental Example 2

A cell A2 was obtained as in Experimental Example A1 except that, in preparing the positive electrode active material, neither the aqueous erbium acetate solution nor the aqueous erbium fluoride solution was added and that the active material obtained in the previous step was used.

### Experimental Example 3

A cell A3 was obtained in as Experimental Example 1 except that only erbium acetate tetrahydrate was added to the lithium transition metal oxide in preparing the positive electrode active material.

### Experimental Example 4

A cell A4 was obtained as in Experimental Example 1 except that only the aqueous ammonium fluoride solution was added to the lithium transition metal oxide in preparing the positive electrode active material.

The cells A1 to A4 obtained in the Experimental Examples described above were used to conduct the following charge-discharge test.

Initial Charge-Discharge Properties Charging: Constant-current charging was conducted under a temperature condition of 25° C. at a current density of 0.4 mA/cm² until 4.3 V (vs. Li/Li⁺) was reached, and then constant-voltage charging was conducted at a constant voltage of 4.3 V (vs. Li/Li⁺) until the current density was 0.08 mA/cm².

Discharging: Constant-current discharging was conducted under a temperature condition of 25° C. at a current density of 0.4 mA/cm² until 2.5 V (vs. Li/Li⁺) was reached.

After the charging and discharging described above, the initial discharge capacity was measured and assumed to be the rated discharge capacity.

Measurement of Low-Temperature Output Characteristics

After charging was performed under a temperature condition of 25° C. at a current density of 0.4 mA/cm² until 50% of the rated capacity was reached, the atmosphere temperature was changed to −30° C., and then discharge was performed at a current density of 0.16, 0.8, 1.6, 2.4, 3.2, and 4.8 mA/cm² each for 10 seconds so as to measure the cell voltage. The current density values and the cell voltage were plotted, and the current density at which the cell voltage was 2.5 V after 10 seconds of discharging was determined. This current density multiplied by 2.5 V was assumed to be the output density, and the value of the output density relative to 100 of the output density of Experimental Example 2 is presented in Table 1.

The depth-of-charge deviating by discharging was returned to the initial depth-of-charge by performing constant-current charging at 0.16 mA/cm².

TABLE 1

| | Compound attached to surface | Low-temperature output |
|---|---|---|
| Experimental | ErOOH + LiF | 126 |
| Example 1 | | |
| Experimental | None | 100 |
| Example 2 | | |
| Experimental | ErOOH | 96 |
| Example 3 | | |
| Experimental | LiF | 75 |
| Example 4 | | |

Table 1 demonstrates that Experimental Example 1 in which erbium oxyhydroxide and lithium fluoride are attached to the surfaces of the lithium transition metal oxide particles exhibits significantly improved low-temperature output characteristics compared to Experiment 2. In contrast, in Experimental Example 3 in which only erbium oxyhydroxide is attached and Experimental Example 4 in which only LiF is attached degradation of low-temperature output characteristics occurred. The reason for this is presumably as follows.

When erbium oxyhydroxide and LiF are simultaneously attached, presence of erbium hydroxide decreases the activation energy for the desolvation reaction at the active material surface, and desolvated Li ions are smoothly intercalated into the interior of the active material through LiF attached to the sites near erbium oxyhydroxide and through coatings formed by incorporating LiF. Thus, excellent low-temperature output is obtained.

In contrast, when only erbium oxyhydroxide is attached, activation energy is still low; however, erbium oxyhydroxide itself has low lithium ion conductivity and inhibits ion conduction in the sites to which erbium oxyhydroxide is attached and the surrounding sites, and thus low-temperature output is decreased.

When only LiF is attached, the activation energy for desolvation reaction significantly increases compared to the active material with no attached compounds, and thus low-temperature output is decreased.

### Experimental Example 5

A cell A5 was obtained as in Experimental Example 1 except that a solution prepared by dissolving 3.71 g of neodymium nitrate hexahydrate instead of 3.76 g of erbium acetate tetrahydrate in 50 mL of pure water was used in preparing the positive electrode active material. The attached neodymium hydroxide does not turn into an oxyhydroxide at 250° C. and remains as a hydroxide.

### Experimental Example 6

A cell A6 was obtained as in Experimental Example 1 except that a solution prepared by dissolving 3.77 g of samarium nitrate hexahydrate instead of 3.76 g of erbium acetate tetrahydrate in 50 mL of pure water was used in preparing the positive electrode active material. The attached samarium hydroxide does not turn into an oxyhydroxide at 250° C. and remains as a hydroxide.

The cells A5 and A6 obtained in Experimental Examples 5 and 6 were used to conduct the same charge-discharge test as that for Experimental Examples A1 to A4. The results are indicated in Table 2 below.

TABLE 2

| | Compound attached | |
|---|---|---|
| | to surface | Low-temperature output |
| Experimental Example 1 | ErOOH + LiF | 126 |
| Experimental Example 5 | Nd(OH)₃ + LiF | 118 |
| Experimental Example 6 | Sm(OH)₃ + LiF | 120 |
| Experimental Example 2 | None | 100 |

The results of Table 2 clearly demonstrate that Experimental Example 5 in which neodymium hydroxide and lithium fluoride are attached to surfaces of a lithium transition metal oxide particles and Experimental Example 6 in which samarium hydroxide and lithium fluoride are attached exhibit significantly improved low-temperature output characteristics compared to Experimental Example 2. It can be assumed from these results that the effect of improving low-temperature output characteristics is an effect of the rare earth compound, and the same effect is obtained with other rare earth elements as well.

Since the effect of improving the low-temperature output characteristics in Experimental Example 1 is the largest compared to Experimental Examples 5 and 6, erbium is most preferable among the rare earth elements.

(Other Features)

Examples of the rare earth element contained in the rare earth compound include scandium, yttrium, lanthanum, cerium, praseodymium, neodymium, samarium, europium, gadolinium, terbium, dysprosium, holmium, erbium, thulium, ytterbium, and lutetium. Among these, neodymium, samarium, and erbium are preferable. This is because compounds of neodymium, samarium, or erbium have a smaller average particle diameter than other rare earth compounds and tend to more evenly disperse into the surfaces of the lithium transition metal oxide particles and to easily form precipitates; thus, the synergetic effect with a compound containing Li and fluorine is enhanced.

Specific examples of the rare earth compound include hydroxides and oxyhydroxides such as neodymium hydroxide, neodymium oxyhydroxide, samarium hydroxide, samarium oxyhydroxide, erbium hydroxide, and erbium oxyhydroxide; phosphate compounds and carbonate compounds such as neodymium phosphate, samarium phosphate, erbium phosphate, neodymium carbonate, samarium carbonate, and erbium carbonate; and neodymium oxide, samarium oxide, and erbium oxide. Among these, hydroxides and oxyhydroxides of rare earth elements are preferable since they can be more evenly dispersed and the low-temperature output is not degraded even when charging and discharging are conducted as usual in a wide temperature range and a wide charge voltage range.

The average particle diameter of the rare earth compound is preferably 1 nm or more and 100 nm or less, and more preferably 10 nm or more and 50 nm or less. When the average particle diameter of the rare earth compound exceeds 100 nm, the particle diameter of the rare earth compound is increased and the number of particles of the rare earth compound is decreased. As a result, the effect of improving the low-temperature output may be diminished.

In contrast, when the average particle diameter of the rare earth compound is less than 1 nm, the surfaces of the particles of the lithium transition metal oxide are densely coated with the rare earth compound, and lithium ion intercalation or deintercalation performance at the particle surfaces of the lithium transition metal oxide is degraded, which may result in degraded charge-discharge properties.

The solution of a rare earth element or the like is obtained by dissolving a sulfate compound, acetate compound, or nitrate compound of a rare earth or the like in water or by dissolving an oxide or a rare earth in nitric acid, sulfuric acid, or acetic acid.

The ratio of the rare earth compound to the total mass of the lithium transition metal oxide is preferably 0.005% by mass or more and 0.5% by mass or less and more preferably 0.05% by mass or more and 0.3% by mass or less in terms of a rare earth element. When the ratio is less than 0.005% by mass, the effect of the compound containing the rare earth element and the compound containing lithium and fluorine is not sufficiently obtained, and the effect of improving the low-temperature output characteristics may not be sufficiently obtained.

Moreover, when the ratio is 0.5% by mass or more, the surfaces of the lithium transition metal oxide are excessively covered, and the cycle properties in large-current discharging may be degraded.

The ratio of the compound containing lithium and fluorine relative to the total mass of the lithium transition metal oxide is preferably 0.005% by mass or more and 0.8% by mass or less, and more preferably 0.01% by mass or more and 0.4% by mass or less in terms of a fluorine element. When the ratio is less than 0.005% by mass, the effect of the compound containing a rare earth element and the compound containing lithium and fluorine is not sufficiently obtained the effect of improving the low-temperature output characteristics may not be sufficiently obtained. Moreover, at a ratio exceeding 0.8% by mass, the amount of the positive electrode active material decreases correspondingly, and thus the positive electrode capacity is decreased.

The lithium transition metal oxide is, for example, a Ni—Co—Mn lithium complex oxide described above or may be a Ni—Co—Al lithium complex oxide that offers a high capacity and high input-output characteristics as with Ni—Co—Mn. Other examples include lithium cobalt complex oxides, Ni—Mn—Al lithium complex oxides, and an olivine-type transition metal oxide containing iron, manganese, or the like (represented by LiMPO₄ where M is selected from Fe, Mn, Co, and Ni). These may be used alone or as a mixture.

Examples of the Ni—Co—Mn lithium complex oxide include those having known compositions such as those having a Ni/Co/Mn molar ratio of 35:35:30 as described above, 5:2:3, or 6:2:2. In particular, in order to enable an increase in positive electrode capacity, Ni—Co—Mn lithium complex oxides whose Ni and Co ratios are greater than the Mn ratio are preferably used; and the difference between the molar ratio of Ni and the molar ratio of Mn to the total of moles of Ni, Co, and Mn is preferably 0.04% or more. When positive electrode active materials of the same type only or of different types are used, the particle diameters of the positive electrode active materials may be the same or different.

The lithium transition metal oxide may contain other additive elements. Examples of the additive elements include boron (B), magnesium (Mg), aluminum (Al), titanium (Ti), chromium (Cr), iron (Fe), copper (Cu), zinc (Zn), niobium (Nb), molybdenum (Mo), tantalum (Ta), zirconium (Zr), tin (Sn), tungsten (W), sodium (Na), potassium (K), barium (Ba), strontium (Sr), and calcium (Ca).

The negative electrode active material used in the negative electrode of the nonaqueous electrolyte secondary battery of the present invention may be any material that can reversibly intercalate and deintercalate lithium. Examples thereof include carbon materials, metals or alloy materials such as Si and Sn that alloy with lithium, and metal oxides. Negative electrode active materials selected from carbon materials, the metal oxides, and metal and alloy materials may be used in combination.

Examples of the nonaqueous electrolyte used in the nonaqueous electrolyte secondary battery of the present invention include cyclic carbonates such as ethylene carbonate, propylene carbonate, butylene carbonate, and vinylene carbonate, and linear carbonates such as dimethyl carbonate, methyl ethyl carbonate, and diethyl carbonate that have been conventionally used. In particular, a mixed solvent containing a cyclic carbonate and a linear carbonate is preferably used as a nonaqueous solvent having low viscosity, low melting point, and high lithium ion conductivity. The volume ratio of the cyclic carbonate to the linear carbonate in the mixed solvent is preferably adjusted within the range of 2:8 to 5:5.

Together with the solvent described above, the followings can be used: ester-containing compounds such as methyl acetate, ethyl acetate, propyl acetate, methyl propionate, ethyl propionate, and γ-butyrolactone; sulfone-group-containing compounds such as propanesultone; ether-containing compounds such as 1,2-dimethoxyethane, 1,2-diethoxyethane, tetrahydrofuran, 1,3-dioxane, 1,4-dioxane, and 2-methyltetrahydrofuran; nitrile-containing compounds such as butyronitrile, valeronitrile, n-heptanenitrile, succinonitrile, glutaronitrile, adiponitrile, pimelonitrile, 1,2,3-propanetricarbonitrile, and 1,3,5-pentanetricarbonitrile; and amide-containing compounds such as dimethylformamide. Solvents of these compounds in which some of hydrogen atoms H are substituted with fluorine atoms F can also be used.

Examples of the lithium salt used in batteries that use the positive electrode active material for the nonaqueous electrolyte secondary battery of the present invention include conventional fluorine-containing lithium salts such as LiPF₆, LiBF₄, LiCF₃SO₃, LiN(FSO₂)₂, LiN(CF₃SO₂)₂, LiN(C₂F₅SO₂)₂, LiN(CF₃SO₂)(C₄F₉SO₂), LiC(C₂F₅SO₂)₃, and LiAsF₆. A mixture prepared by adding a lithium salt (a lithium salt containing at least one selected from P, B, O, S, N, and Cl, e.g., LiClO₄) other than fluorine-containing lithium salts to a fluorine-containing lithium salt may also be used. In particular, in order to form a stable coating film on a surface of a negative electrode in a high-temperature environment, a fluorine-containing lithium salt and a lithium salt with an oxalato-complex serving as an anion are preferably contained.

Examples of the lithium salt with an oxalato-complex serving as an anion include LiBOB (lithium-bisoxalate borate), Li[B(C₂O₄) F₂], Li[P(C₂O₄) F₄], and Li[P(C₂O₄)₂F₂]. Among these, LiBOB that forms a stable coating film on a negative electrode is preferably used.

Examples of the separator used in the nonaqueous electrolyte secondary battery of the present invention include conventional separators such as polypropylene or polyethylene separators, polypropylene-polyethylene multilayer separators, and separators having surfaces coated with resins such as aramid resins.

A layer formed of an inorganic filler which has been conventionally used may be formed at the positive electrode/separator interface or the negative electrode/separator interface. Examples of the filler include conventional fillers such as oxides and phosphate compounds that use one or more selected from titanium, aluminum, silicon, magnesium, etc., and the oxides and phosphate compounds having surfaces treated with hydroxides or the like. Examples of the technique of forming the filler layer include a technique that involves directly applying a filler-containing slurry to a positive electrode, a negative electrode or a separator, and a technique that involves bonding a sheet formed of a filler onto a positive electrode, a negative electrode, or a separator.

One method for obtaining an active material in which a compound containing a rare earth element and a compound containing lithium and fluorine are attached to a surface of a lithium transition metal oxide is, a described above, a method in which a solution A of a salt containing a rare earth element and a solution B containing a fluorine source are added to a lithium transition metal oxide under stirring in such a manner that the solutions A and B do not come into contact with each other before the solutions touch the lithium transition metal oxide, so as to have a compound containing a rare earth element and a compound containing lithium and fluorine attached to the surface of the lithium transition metal oxide.

As for the method of adding the solution A and the solution B, the solutions are preferably added in divided portions. This is because the compound containing a rare earth element and the compound containing lithium and fluorine disperse more evenly as they attach to the surface of the lithium transition metal oxide.

Examples of the method for adding the solutions in divided portions include a method of adding dropwise the solutions to the active material from nozzles while stirring the positive electrode active material and a method of spraying the solutions with sprays to make the solutions attach to the active material.

As for the method of adding the solution A and the solution B, the solution A and the solution B preferably come into contact with the lithium transition metal oxide almost simultaneously.

The lithium transition metal oxide before making contact with the solution A and the solution B described above preferably contains a lithium compound not contained in the crystals. A compound containing lithium and fluorine (for example, lithium fluoride) is easily formed upon contact with the solution B. When the lithium compound not contained in the crystals is not contained, lithium inside the crystals is abstracted and a compound containing lithium and fluorine is formed. In such a case, the amount of lithium that contributes to charging and discharging is decreased and thus the capacity may be decreased.

When aqueous solutions are used as the solutions, the total weight of the solutions added (the total weight of the solution of the compound containing a rare earth element and the solution of the compound containing lithium and fluorine) is preferably adjusted so that the liquid/solid ratio (weight ratio of lithium transition metal oxide) obtained by formula (1) below is 4% or more and 10% or less.

At less than 4%, the amount of the solutions added is excessively small, and the compound containing a rare earth element and the compound containing lithium fluorine do not easily evenly attach to the lithium transition metal oxide. Thus, the low-temperature output characteristic improving effect may not be sufficiently obtained. At exceeding 10%, the lithium transition metal oxide combined with the solutions comes to contain a large quantity of solutions and drying takes time, resulting in lower productivity. Due to these reasons, the ratio is preferably 4% or more and 10% or less.

Liquid/solid ratio=total weight (g) of solutions added/weight (g) of lithium transition metal oxide×100 (1)

When aqueous solutions are used as the solutions, the pH of each solution added is preferably 2 or more and more preferably 4 or more. This is because some part of the active material may be dissolved by the acid at a pH less than 2.

When a solution having a pH of 2 or more and less than 4 is added to a lithium transition metal compound, lithium inside the crystals and hydrogen ions in the solution are exchanged, and the properties of the lithium transition metal oxide may be degraded.

The positive electrode active material may be stirred with conventional stirring equipment. Examples thereof include planetary mixers such as HIVIS MIX and stirring devices such as drum mixers and Loedige mixers.

1. A positive electrode active material for a nonaqueous electrolyte secondary battery, wherein a compound containing a rare earth element and a compound containing lithium and fluorine are attached to a surface of a positive electrode active material formed of a lithium transition metal oxide.

2. The positive electrode active material for a nonaqueous electrolyte secondary battery according to claim 1, wherein the compound containing a rare earth element attached to the surface of the positive electrode active material is at least one selected from a hydroxide, an oxyhydroxide, a phosphate compound, a carbonate compound, and an oxide.

3. The positive electrode active material for a nonaqueous electrolyte secondary battery according to claim 1, wherein the compound containing a rare earth element is a hydroxide or an oxyhydroxide.

4. The positive electrode active material for a nonaqueous electrolyte secondary battery according to claim 1, wherein the compound containing a rare earth element is at least one selected from neodymium, samarium, and erbium.

5. The positive electrode active material for a nonaqueous electrolyte secondary battery according to claim 1, wherein the compound containing lithium and fluorine is lithium fluoride.

6. A nonaqueous electrolyte secondary battery comprising the positive electrode active material for a nonaqueous electrolyte secondary battery according to claim 1.
